(19) United States
(12) Patent Application Publication
(10) Pub. No.: US 2026/0240389 A1
(43) Pub. Date: Aug. 20, 2026

(54) SEPARATION SYSTEM FOR A VACUUM CLEANER

(71) Applicant: Dyson Technology Limited, Malmesbury, Wiltshire (GB)

(72) Inventor: Arjun SELVARAJAH, Swindon (GB)

(21) Appl. No.: 18/872,383

(22) PCT Filed: Jun. 22, 2023
(86) PCT No.: PCT/IB2023/056450

§ 371 Date: Dec. 6, 2024

(30) Foreign Application Priority Data
Jun. 29, 2022 (GB) 2209560.8
Jun. 29, 2022 (GB) 2209561.6

(51) Int. Cl. A47L 9/12; A47L 9/28; A47L 9/32; B01D 46/16; B01D 46/52

(52) U.S. Cl. CPC A47L 9/127; A47L 9/2884; A47L 9/325; B01D 46/16; B01D 46/521; B01D 2279/55

(57) ABSTRACT

A separation system for a vacuum cleaning appliance is provided and includes a vacuum generator, an outlet chamber, an air permeable filter arrangement, and an air inlet pipe. The outlet chamber extends in a first direction and defines an air outlet. Air is drawn through the outlet chamber in the first direction by the vacuum generator, in use, towards the air outlet. The air permeable filter arrangement separates the outlet chamber from a dirt collection chamber. The air inlet pipe extends through a portion of the outlet chamber and includes a throat portion defining a discharge opening into the dirt collection chamber. The throat portion extends in a second direction transverse to the first direction. The throat portion of the air inlet pipe defines a streamlined outer profile in respect of the first direction of air flow through the outlet chamber to the air outlet.

### TECHNICAL FIELD

The present invention relates to a separation system for separating dust from a stream of air, particularly in the context of a vacuum cleaner.

### BACKGROUND

Handheld vacuum cleaners and ‘stick vacs’ are popular household machines as they are lightweight and manoeuvrable compared to larger mains-connected cylinder and upright cleaners. The useful portability is usually achieved at least in part by being battery-powered, and many such machines now are bagless for convenience such that the collected dirt is stored in an integral dirt bin. Typically, handheld machines are used for frequent spot cleaning tasks but, as battery technology improves, the trend is towards longer cleaning operations. The trend for handheld vacuum cleaners to be the cleaner of choice for many households means that some users may prefer a larger dirt bin so that the cleaner can hold more dirt and debris between bin empties. Whilst there is some market pressure to make handheld vacuum cleaners larger and more substantial so that they are better able to take over the conventional tasks of larger, mains-connected machines, there is also increasing demand for smaller machines which are lighter and more wieldy, particularly to reach up high. One example of this is the Dyson Micro 1.5 km™ vacuum cleaner, and another example is the Shark WandVac system.

A challenge with reducing the size of such handheld machines is the need to maintain the effectiveness of the separation system despite the packaging constraints. Cyclonic separation systems are typically problematic to engineer into such a small package. It is against this background that the invention has been devised.

### SUMMARY

In a first aspect, the invention provides a separation system for a vacuum cleaning appliance, comprising a vacuum generator; an outlet chamber which extends in a first direction and which defines an air outlet, wherein air is drawn through the outlet chamber in the first direction by the vacuum generator, in use, towards the air outlet. The system further includes an air permeable filter arrangement separating the outlet chamber from a dirt collection chamber. An air inlet pipe extends through at least a portion of the outlet chamber, and includes a throat portion which defines a discharge opening into the dirt collection chamber; wherein the throat portion extends in a second direction that is transverse to the first direction. The throat portion of the air inlet pipe is shaped to define a streamlined outer profile in respect of the first direction of air flow through the outlet chamber to the outlet opening.

Beneficially, the streamlined outer profile/surface of the inlet pipe has the effect of improving the smoothness of airflow through the outlet chamber towards the outlet opening by reducing flow separation as the air flows around the inlet pipe. The streamlined shape helps recover some of the flow energy normally wasted in creation of separated flow, which has the effect of reducing the pressure drop of the separation system.

In one example, the streamlined outer profile may be generally teardrop shape so as to define a bluff leading section that points into the oncoming airflow and a streamlined trailing section that points into the receding airflow. The profile could also be generally oval in shape. As such, the outer profile oof the throat position may be considered to have a first dimension aligned with the first direction and a second dimension aligned with a third direction that is perpendicular to the second direction, wherein the first dimension is greater than the second dimension.

The internal shape of the throat portion of the inlet pipe need not be the same as the outer profile. For example the inner profile of the throat portion could be circular or oval, or whatever shape is determined best for internal flow through the pipe. Where the inner profile is oval, the shape may be configured to that the major axis thereof is transverse to the first direction. This provides a somewhat flattened overall shape that extends across the airflow direction and which may be beneficial in terms of airflow.

The separation system may be configured in a compact manner such that the dirt collection chamber also extends along the first direction. The dirt collection and outlet chamber may be parallel to one another. The two chambers may have substantially the same length, or one chamber may be longer than the other.

The outer profile of the two chambers may define a general cylindrical shape. The aspect ratio of the separation may be ‘tall and slim’ such that the diameter of the cylindrical profile is less than 50% of the length of the output chamber along the first direction, and alternatively less than 20% or even 10% of the length of the output chamber along the first direction. Furthermore, optionally the dirt collection chamber is parallel to the outlet chamber, the throat portion of the inlet pipe may be adjacent the outlet opening. These features promote a slim and compact package for the separation system and make the separation system particularly suitable for use in light weight handheld vacuum cleaners.

The separation system may include a filter sheet that separates the outlet chamber and the dirt collection chamber. Preferably that filter sheet extends along at least half of the length of the chambers, and preferably greater than 60%, or 70% or 80% of the chamber length.

The filter sheet may comprise two portion, each being angled with respect to one another to define a spine between them. The angle between the two filter sheets can be varied to change the relative volumes of the outlet chamber and the dirt collection chamber.

The filter sheet may be configured so that it is generally V-shaped along its length, thereby being defined by two adjacent filter portions. The relative angle of the two filter portions may be varied to change the relative volume of the dirt collection chamber and the outlet chamber. Preferably the air outlet is adjacent the discharge opening.

The invention also embraces a vacuum cleaning appliance comprising a handle, a user-operable interface, a power source and a separation system as defined above.

Features described above in connection with the first aspect of the invention are equally applicable to the second and third aspects of the invention, and vice versa.

In another aspect, the invention provides a separation system for a vacuum cleaning appliance, comprising a vacuum generator and an outlet chamber which extends in a first direction and which defines an air outlet, wherein air is drawn through the outlet chamber in the first direction by the vacuum generator, in use, towards the air outlet. The system further includes an air permeable filter arrangement separating the outlet chamber from a dirt collection chamber. An air inlet pipe extends through at least a portion of the outlet chamber and defines a discharge opening into the dirt collection chamber, wherein the inlet pipe has a flow area that increases along at least a portion of its length such that the air inlet pipe defines a first flow area at an upstream position relative to the discharge opening, wherein the discharge opening defines a second flow area, wherein the second flow area is larger than the first flow area.

Beneficially, increasing the flow geometry between the first flow area and the second flow area means that the air flow speed through the inlet pipe is reduced before it passes through the discharge opening. In turn, this has the result of reducing the pressure drop through the system because the air flow through the dirt collecting chamber has a reduced flow separation. Such a configuration enables a compact separation system to be provided whilst mitigating the reduction in separation efficiency which tends to accompany a more compact separation system.

In one example, the flow area of the air inlet pipe increases continuously from the first flow area to the second flow area. A continual and gradual increase in flow area avoids step changes in internal pipe geometry which may otherwise increase turbulence and noise. The first flow area may be defined by a first portion of the air inlet pipe which extends through the outlet chamber along the first direction. The first portion may have a substantially constant flow area along its length before increasing in dimension to the second flow area.

The discharge opening may be defined by a second portion of the air inlet pipe which extends in a second direction which is generally traverse to the first direction. A transversely extending section of pipe is useful in the context of a compact separation system but it can cause an obstruction to air flow through the outlet chamber. Suitable streamline features may be carried by the second portion to improve airflow past it.

A transition portion may extend between the first and second portions of the inlet pipe which may follow a curved path between the first direction of the first portion and the transverse direction of the second portion. The radius of the curved path may be configured to limit the impact on airflow through the pipe so as to avoid pressure drop increase.

The second flow area may be no more than 150% larger than the first flow area and, optionally, no more than 120% larger, and, optionally between 100% and 120% larger

The separation system may be configured in a compact manner such that the dirt collection chamber also extends along the first direction. The dirt collection and outlet chamber may be parallel to one another. The two chambers may have substantially the same length, or one chamber may be longer than the other.

The outer profile of the two chambers may define a general cylindrical shape. The aspect ratio of the separation may be ‘tall and slim’ such that the diameter of the cylindrical profile is less than 50% of the length of the output chamber along the first direction, and alternatively less than 20% or even 10% of the length of the output chamber along the first direction. The makes the separation system particularly suitable for use in light weight handheld vacuum cleaners.

The filter sheet may be configured so that it is generally V-shaped along its length, thereby being defined by two adjacent filter portions. The relative angle of the two filter portions may be varied to change the relative volume of the dirt collection chamber and the outlet chamber. Preferably the air outlet is adjacent the discharge opening.

The invention also embraces a vacuum cleaning appliance comprising a handle, a user-operable interface, a power source and a separation system as defined above.

### BRIEF DESCRIPTION OF THE DRAWINGS

FIG. 1 is a perspective view of a handheld vacuum cleaner in which an exemplary separation system of the invention may be incorporated;

FIG. 2 is a schematic view of the vacuum cleaner in FIG. 1 showing some hidden detail;

FIGS. 3a and 3b are a pair of views that show a separation system from different viewing perspectives so the features may be best appreciated, where it should be noted that the separation system shown in these views does not embody examples of the invention;

FIG. 4 is a schematic view of the separation system shown in FIGS. 3a and 3b which shows the airflow through the separation system;

FIGS. 5a and 5b are a pair of views that show a separation system that is similar to that shown in FIGS. 3a and 3b but exemplifying a first aspect of the invention;

FIGS. 6a and 6b are a pair of views that show a separation system that is similar to that shown in FIGS. 3a and 3b but exemplifying a second aspect of the invention;

FIGS. 7a and 7b are schematic views of two different separation systems for comparison, wherein FIG. 7b depicts the separation system from FIGS. 6a and 6b, and FIG. 7 a depicts the separation system from FIGS. 3 a and 3 b.

### DETAILED DESCRIPTION

Examples of the invention relate to a separation system for a vacuum cleaner, and particularly a handheld vacuum cleaner where the compact configuration of the separation system is particularly useful and makes for a more effective and ergonomic machine. In such a separation system, the inlet pipe into the dirt collection chamber extends through and across at least a portion of the outlet chamber to discharge into the dirt collection chamber. Clean air flows at high velocity through the outlet chamber past the inlet pipe towards the outlet of the separation system. Furthermore, dirty air flows into the dirt collection chamber at high velocity to be filtered by the filtering arrangement therein. The arrangement of the inlet pipe extending through the outlet chamber, and the configuration of the discharge outlet into the dirt collection chamber are sources of pressure drop through the system which can reduce effectiveness. Examples of the invention provide a separation system of this type which configures the inlet pipe to reduce the pressure drop of the airflow through the outlet chamber. Further examples of the invention configure the discharge opening of the inlet pipe into the dirt collection chamber to improve airflow characteristics and reduce the pressure drop of the system still further. The examples of the invention as described here may be combined or they may be implemented separately.

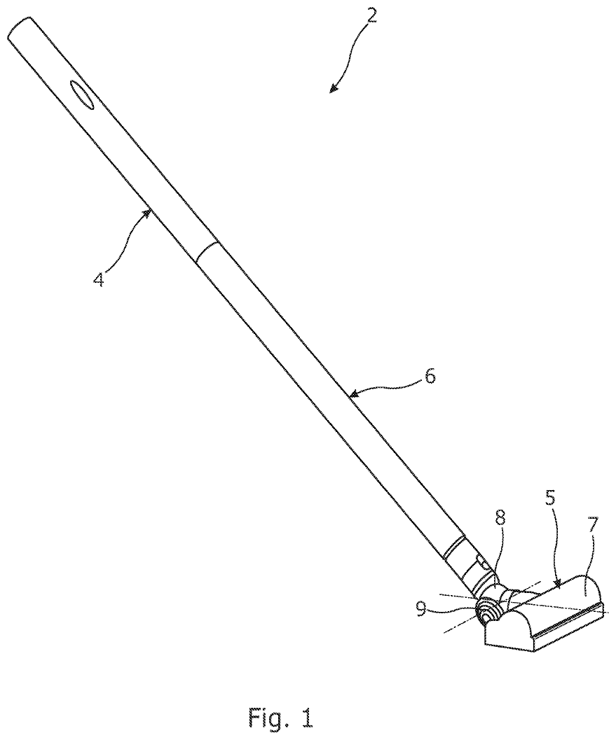

With reference to FIG. 1, a vacuum cleaner 2 includes an elongated body 4 which is attached to a cleaning tool 5 by a removable pipe or ‘wand’ 6. The wand 6 may be separable from the body 4. Likewise, the cleaning tool 5 may be separable from the wand 6.

The cleaning tool 5 is shown here as a motorised floor tool which includes a generally cylindrical housing 7 which accommodates a motor-driven brush bar (not shown). The cleaning tool 5 also includes an articulated joint 8 that has a wheel arrangement 9 that allows the cleaning tool 5 to be guided across a surface to be cleaned by a user controlling twisting movement of the body 4 of the vacuum cleaner 2. FIG. 1 does not show a surface to be cleaned, but its presence is implied.

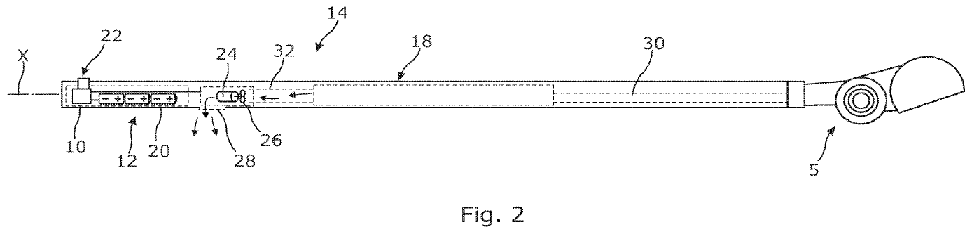

It should be noted that the type of cleaning tool 5 shown here is known and is not the focus of the invention. Other cleaning tools can be used. For example, instead of a motor-driven floor tool, as shown in FIG. 1, the vacuum cleaner 2 may have a passive tool such as a crevice tool or a mattress tool attached to it.

Whereas FIG. 1 shows a broad overview of the general external configuration of the vacuum cleaner 2, FIG. 2 shows the vacuum cleaner 2 schematically so that its internal components can be appreciated more completely.

In overview, the vacuum cleaner comprises a control system 10, a power system 12 and a separation system 14, including an airflow generator 16 and a dirt separator 18.

The power system 12 in this example includes a battery pack 20. Batteries are preferred in this example for portability, although the power system may also be embodied by a power cable. The control system 10 is coupled to the power system 12 and controls the application of power to the airflow generator 16 under the command of a user interface 22. The user interface 22 may be a simple on-off touch switch, or it may be a more sophisticated interface comprising a touch screen, for example. The user interface provides the user with the means to turn the vacuum cleaner on and off, and may also provide the option of other functionality, for example the display of battery life, filter life, run time and so on.

The airflow generator 16 comprises an electric motor 24 that is powered by the battery pack 20 under the control of the control system 10. A fan 26 coupled to the electric motor 24 generates a flow of air through the machine, from the cleaning tool 6, through the dirt separator 18 past the airflow generator 16 and out of an air outlet 28. A filter (not shown) may be provided at the air outlet to filter fine particles of dirt from the airflow out of the machine. The filter may be a HEPA filter. The filter may be removable.

Air flow is routed from the cleaning tool 5 to the dirt separator 18 by an inlet conduit 30. The inlet conduit 30 may define an outer surface of the vacuum cleaner 2, or it may be an internal conduit which is surrounded by a casing, as shown here.

Air flow is routed from the dirt separator 18 to the airflow generator 16 by an outlet conduit 32. Again, the outlet conduit 32 may define an outer surface of the vacuum cleaner 2 or it may be inside an external machine casing, as shown here.

As can be seen in FIGS. 1 and 2, the vacuum cleaner 2 has a substantially linear configuration and extends along a machine axis X. The outer profile of the vacuum is substantially cylindrical about the machine axis X and has a generally constant lateral dimension of between 35 mm and 50 mm. Preferably the maximum lateral dimension along the length of the vacuum cleaner is 38 mm. This provides the vacuum cleaner 2 with a very compact general configuration and low mass which improvise the machine ergonomics.

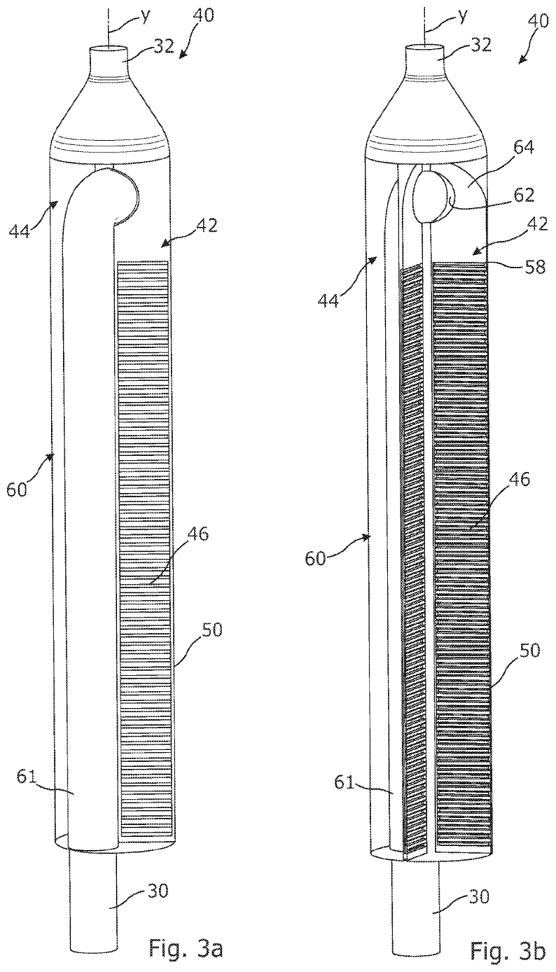

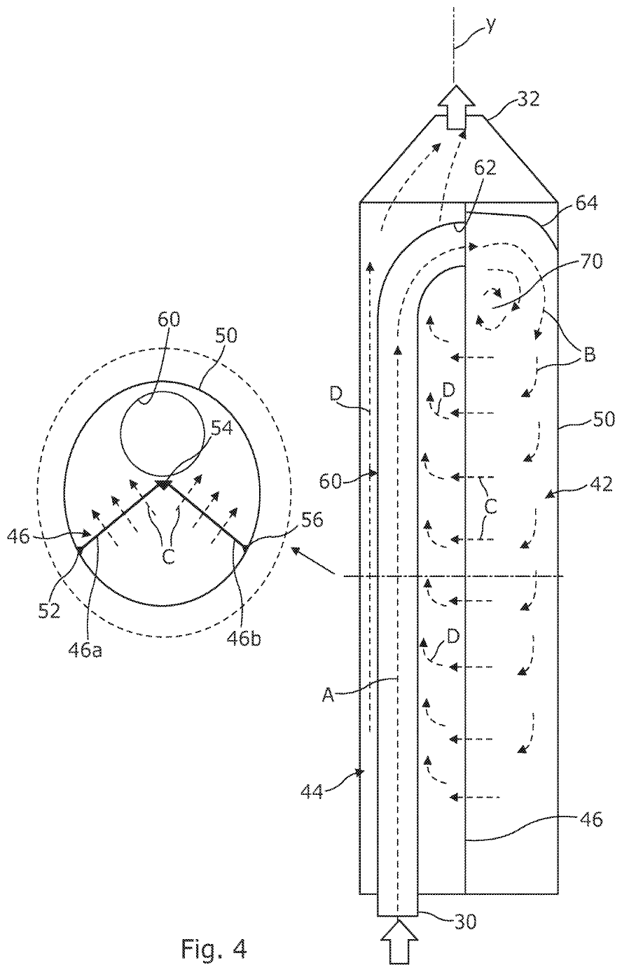

In FIG. 2 the dirt separator 18 is shown in schematic form. However, an example of a dirt separator 18 that may be used is shown in FIGS. 3a,3b and FIG. 4. This example of dirt separator is not the focus of the invention but is described here to provide context to the examples of the invention that will be described later. The dirt separator in this Figure will be referenced as ‘40’.

The dirt separator 40 has an outer form that is generally cylindrical and which defines two main chambers that are arranged adjacent one another. The chambers are elongated but relatively narrow which provides a long a slender outer form that helps keep a narrow outer diameter for the vacuum cleaner 2. A first one of the chambers is a dirt collection chamber 42 into which air laden with dirt and debris flows to be cleaned. A second one of the chambers is an outlet chamber 44. Air flows from the dirt collection chamber 42 into the outlet chamber 44 through a filter arrangement 46. The filter arrangement 46 in this example separates the dirt collection chamber 42 from the outlet chamber 44. Air flows out of the outlet chamber 44 through the outlet conduit 32.

As can be seen from the figures, and particularly well from FIG. 4, the dirt collection chamber 42 and the outlet chamber 44 extend along a separator axis Y. The axis Y may be coexistent with machine axis X or may be displaced therefrom. The dirt collection chamber 42 and the outlet chamber 44 are approximately the same length end-to-end in this example, although this is not essential.

The dirt collection chamber 42 and the outlet chamber 44 have different respective cross sectional areas, when considered in a plane perpendicular to axis Y. This is seen in the inset panel in FIG. 4. As will be appreciated, the dirt collection chamber 44 and the outlet chamber 44 are defined by a common outer wall 50. The outer wall 50 is cylindrical, in this example.

The filter arrangement 46 extends through the interior defined by the outer wall 50 and therefore partitions that interior into the dirt collection chamber 42 and the outlet chamber 44.

The filter arrangement 46 is sheet-like or planar in form and extends between two areas on the outer wall 50. In one example the filter arrangement 46 may be a pleated sheet which provides a greater surface area for effective filtration. Here, the filter arrangement 46 is therefore a surface filter medium which is pleated to increase its surface area. However, it is envisaged that other forms of filter media may be acceptable for use, for example a depth-based filter medium. The filter media may also be a mesh, e.g. a plastic or metallic mesh.

In this example the filter arrangement 46 has two sections 46a, 46b. First filter section 46a extends between a first area on the outer wall 50 defined by a first filter support 52 and a second, central filter support 54. The second filter section 46b extends between the central filter support 54 and a second area on the outer wall defined by a third filter support 56. The first and third filter supports 52,56 may be any suitable structure to support the linear edges of the filter arrangement 46. For example, they take the form of a rail, e.g. of polymeric material, that extends along the outer wall 50 and defines a slot to accommodate the edge of the respective filter section.

The central support 54 may be defined by a suitable columnar structure that extends from the bottom of the dirt separator 18 to the top or near to the top and is suitably configured to support the area where the first filter section 46a meets the second filter section 46b.

In plan cross section, therefore, the filter arrangement 46 defines a V-shape with the vertex at the central support 54. The vertex and the central support therefore acts as a spine of the filter arrangement 46. The filter sections 46a,46b may be separate filter members, in some examples, or they may define a single sheet which is bent longitudinally at the vertex. Although the central support 54 may be omitted, it is currently preferred in order to provide the filter arrangement 46 with robustness and rigidity. The filter arrangement 46 may be configured to be removable from the dirt separator 18.

Currently, it is envisaged that the filter arrangement 46 comprises a filter support or frame 58 that supports the filter sections 46a,46b. The filter frame 58 may be embodied as a rigid panel, e.g. of plastics material, which holds the relatively flexible filter material in tension within the interior of the outer wall 50.

Although not shown in the figures, the dirt collection chamber 42 may be configured so that it may be emptied. This may be achieved in various ways. For example, a portion of the outer wall 50 may be removable (e.g. hinged) to allow access to the interior so that the dirt can be removed from the chamber 42. Other approaches would also be feasible.

Air flow is admitted into the dirt collection chamber 42 by way of an inlet pipe 60 being an extension of the inlet conduit 30 that extends from the cleaning tool 5. The inlet pipe 60 extends through the outlet chamber 44 and, in this example, extends in a direction that is parallel to the axis Y of the dirt separator 18.

The inlet pipe 60 in this example and extends from a lower end of the outlet chamber 42 towards an upper end of the outlet chamber 42. It should be noted that the terms ‘lower’ and ‘upper’ are in the context of the orientation of the figures. Towards its upper end, the inlet pipe 60 turns through approximately 90 degrees and extends towards the dirt collection chamber 42. A lower portion 61 of the inlet pipe 60 is substantially linear and extends along the longitudinal direction of the outlet chamber 42. The interior of the inlet pipe 60 opens out into the dirt collection chamber 42 thereby defining a discharge opening 62.

The air flow through the dirt separator 18 can be appreciated by FIG. 4. When the airflow generator 16 is activated, a relative vacuum is generated at the outlet conduit 32 of the dirt separator 18. Relatively clean air is therefore drawn out of the outlet chamber 44. In response, dirt-laden air is drawn into the dirt collection chamber 42 through the inlet pipe 60 and the discharge opening 62. The dirty air initially flows through the lower portion 61 of inlet pipe 60 before it turns through 90 degrees and enters into the dirt collection chamber 42 at discharge opening 62. Air flow through the inlet pipe 60 is indicated by arrows A.

It will be appreciated at this point that the airflow must turn through another 90 degrees in order to flow down the dirt collection chamber 42. To assist the redirection, a flow guide 64 is provided in this example. The flow guide 64 may be a separate member located inside the dirt collection chamber 42. Alternatively, the flow guide 64 may be defined by the upper surface of the dirt collection chamber 42. Air flow through the dirt collection chamber 42 is indicated by arrows B.

Air flows downwardly through the dirt collection chamber 42 and through the filter arrangement 46 into the outlet chamber 44. This airflow is indicated by arrows C. Air then is drawn upwardly through the outlet chamber 42 towards the outlet conduit 32 in a direction parallel to the separator axis Y, as indicated by the arrows D.

It will be appreciated at this point that dirty air enters the dirt separator 18 via the inlet pipe 60 which extends through a lower wall (in the orientation of the drawings) of the dirt collector 18 which is at the opposite end of the dirt separator 18 to the outlet conduit 32.

Beneficially, the configuration of dirt separator 18 shown in FIGS. 3a, 3b and 4 has a compact outer profile which makes it particularly suited to use in a handheld vacuum cleaning appliance where it is desirable to have a relative narrow outer profile which helps to reduce the mass of the machine. In particular, the vertical ‘height’ of the internal chambers 42,44 of the dirt separator 18, i.e. the length taken along the first direction, is much greater than the lateral ‘width’ of the dirt separator 18, i.e. its diameter, in this example. Preferably, the height is around five times its width/diameter or, expressed another way, the width/diameter is around 20% or less than the height of the dirt separator. This can be considered as providing an aspect ratio between the height of the chambers 42,44 and the width of the dirt separator 18 of greater than 1:5, up to approximately 1:10.

However, whilst a compact arrangement is desirable, it is challenging to keep the pressure drop across the separator as low as possible in order to maximise the suction power available at the floor tool. Observing FIG. 4, it can be seen that the airflow from the inlet pipe 60 into the dirt collecting chamber 42 must turn through 180 degrees before passing through the filter arrangement 46. This severe change of airflow direction acts as a resistance to air flow which is a contributing factor to the pressure drop across the dirt separator 18. What is more, the change of direction and inherent geometry can cause turbulent airflow, as can be seen by the eddying flow of air in FIG. 4, in the region marked as 70 which can be considered a ‘flow separation zone’.

Another factor that increases flow turbulence is the configuration of the inlet pipe 60 within in the outlet chamber 44, and particularly the way in which a portion of the inlet pipe 60 extends perpendicularly to the flow of air within the outlet chamber 44. Notably, the inlet pipe 60 is circular in cross section, as shown here, which presents a bluff body to the airflow tending to generate excessive turbulence which increases the pressure drop through the system.

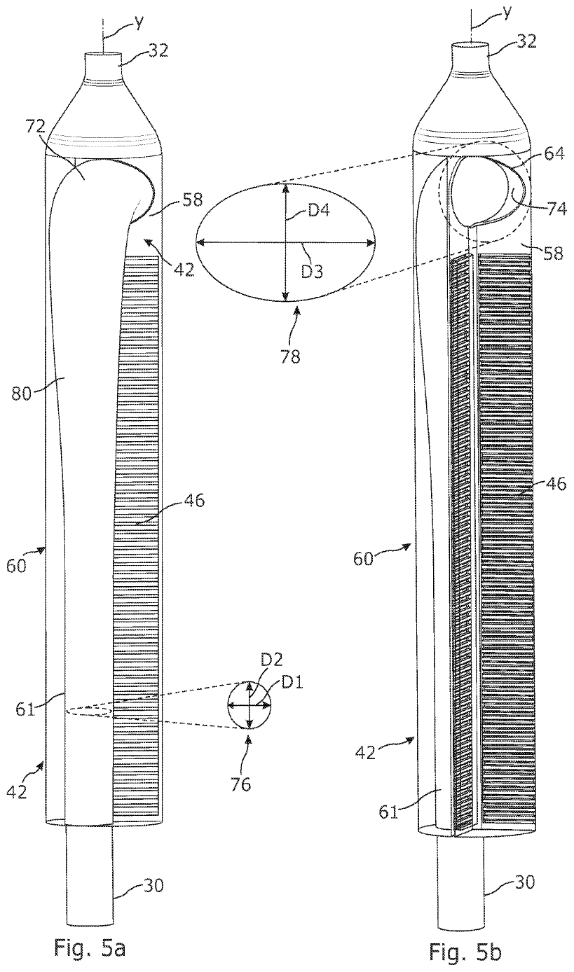

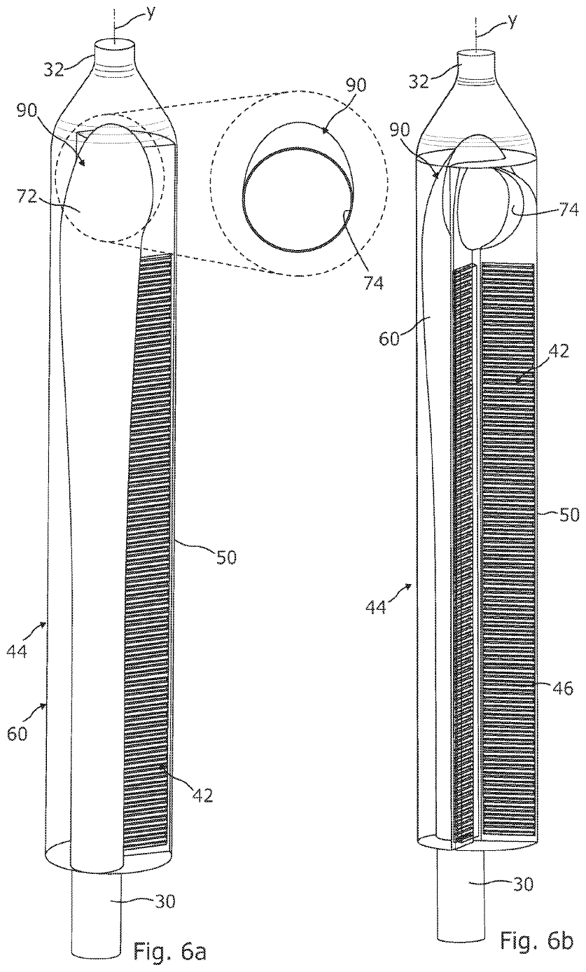

FIGS. 5a and 5b show an example of a dirt separator that addresses some of the issues explained above. FIGS. 6a and 6b show an example of another dirt separator that addresses some of the issues explained above. In these figures, the overall configuration of dirt separator shares many similarities with the dirt separator 40 as explained above and shown in FIGS. 3a, 3b and FIG. 4. The same reference numerals will therefore be used to refer to the same or corresponding features.

Referring firstly to FIGS. 5a and 5b, it will be appreciated that the dirt separator 40 has effectively the same configuration as the dirt separator 18 shown in FIGS. 3a, 3b and 4. Therefore, only the differences will be described here for brevity. Notably, the configuration of the inlet pipe and the discharge opening differs from the equivalent features in the previous Figures.

As can be seen in FIGS. 5a and 5b, the inlet pipe 60 extends through the outlet chamber 44 in a direction parallel to the separator axis Y, in the same way as the previous example. More specifically a first portion 61 of the inlet pipe 60 extends in a first direction aligned with the separator axis Y. The first portion 61 then transitions into a second or ‘throat’ portion 72 that extends transversely to the separator axis Y. More particularly, the throat portion 72 extends perpendicular to the separator axis Y, although strict perpendicularity is not essential. The throat portion 72 defines a discharge opening 74 into the dirt collection chamber 42. The discharge opening 74 is upstream from the filtration media of the filter arrangement 46. Notably in this example the discharge opening 74 is defined in a surface or wall of the filter frame 58 which separates the dirt collecting chamber 42 from the outlet chamber 44.

From studying FIG. 5b particularly, it will be appreciated that the cross sectional area of the inlet pipe 60 is different between the discharge opening 74 and a region of the inlet pipe 60 upstream from the discharge opening 74, when considered in the direction of airflow. This can be appreciated from the two depictions of pipe ‘flow area’, shown as first flow area 76 and second flow area 78. First flow area 76 is taken from a part of the inlet pipe 60 near to the inlet end of the outlet chamber 44. At this point, the inlet pipe 60 has a constant flow area along a portion of its length. Here, the constant flow area section extends for approximately 40% of the length of the outlet chamber 44 along the separator axis Y. However, it is envisaged that the constant flow area section could extend from between 20% to 50% of the length of the outlet chamber 44. The first flow area is circular, in this example, as shown by the orthogonal dimensions labelled D1 and D2. At this point therefore the inlet pipe 60 has a circular profile.

This is to be compared with the second flow area 78 of the discharge opening 74, as shown in FIG. 5b, having dimensions D3 and D4. As can be seen the second flow area 78 is larger than the first flow area 76. It some examples, the second flow area may be between 50% and 300% larger than the first flow area, and preferably below 150% larger, although the exact value will depend on dimensional packaging constraints. Preferably the second flow area is approx. 100-120% greater than the first flow area.

The second flow area 78 may be circular but in this example it is shown as generally elliptical or oval. Dimensions D3 and D4 of second flow area 78 are greater than dimensions D1 and D2 of first flow area 76. Moreover, the dimensions D3 and D4 are not equal. As shown here, the lateral dimension D3 is greater than the longitudinal dimension D4.

In order to provide a smoother flow of air through the inlet pipe 60 between the first flow area 76 and the second flow area 78, in this example the inlet pipe 60 has a transition portion 80 between the first portion 61 and the throat portion 72. As will be appreciated, the transition portion 80 has a flow area that gradually increases along its length. This continuously increasing flow area avoids excessive flow turbulence in the air flow by reducing air speed, and therefore avoids contributing to the pressure drop. Preferably, the gradual increase in flow area means that there are no sharp steps or dimension changes along the length of the inlet pipe between the first portion 61 and the discharge opening 74.

The effect of the increasing flow area along the inlet pipe 60 is to slow down the speed of airflow before it flows out of the discharge opening 74 into the dirt collection chamber 74. This has the effect of reducing circulation of the airflow as it enters the dirt collection chamber 42 (as is shown at region 70 in FIG. 4 by way of demonstration of the problem) and helps to helps to minimise the size of flow separation bubbles in region 70 which aids less turbulent flow to enter the dirt collection chamber 42.]

Turning now to the example dirt separator shown in FIGS. 6a and 6b, it should be noted that it shares many features of the example dirt separators described above. Therefore, for reasons of brevity only the differences will be described here.

The dirt separator 40 in this example of the invention includes a dirt collection chamber 42 and an outlet chamber 44 as the previous example. Furthermore, an inlet pipe 60 extends through the outlet chamber 44 in the first direction, i.e. in line with the separator axis Y.

The inlet pipe 60 extends in a longitudinal direction through the outlet chamber 44. The inlet pipe 60 has a circular outlet profile at a first portion 61 and then widens or tapers outwardly as it extends upwardly through the transition portion 80 towards the upper end of the inlet pipe 60. It should be noted that although the inlet pipe 60 tapers outwardly in this example, it may also maintain a circular outer profile as the first portion 61 of the inlet pipe 60.

At its upper end, the inlet pipe 60 turns through a 90 degree corner at its upper end at which point it extends through the throat portion 72 and defines a discharge opening 74 into the dirt collection chamber 42. The internal shape of the discharge opening 74 is shown in the inset panel in FIG. 6a. As can be seen, the discharge opening 74 has a somewhat ovalised shape in this example which benefits airflow through the throat portion 72 as discussed in the previous example. Here, the generally oval inner profile is shaped so that the major axis thereof is transverse to the first direction. A circular internal profile would also be acceptable in this example. However, an inner profile as described in the previous example would also be acceptable.

What is apparent in viewing the inset panel in FIG. 6a is that the outer profile of the throat portion 72 proximal to the discharge opening 74 is different to the internal profile of the throat portion 72. Conventionally, a pipe would have a wall thickness which is substantially constant throughout its length. In the even the internal shape of the pipe varies along the length of the pipe, the wall thickness would stay substantially constant.

However, in this example of the invention, it can be appreciated that the wall thickness of the inlet pipe 60, in particular the wall thickness of the throat portion 72 of the inlet pipe 60 is varied significantly along the length of the inlet pipe 60. Therefore, the outer profile or shape of the inlet pipe 60 is significantly different to the internal profile of the inlet pipe 60 at least in the region of the discharge opening 74.

The purpose of changing the outer profile of the inlet pipe 60 in this example is to provide the inlet pipe 60 with a streamlined outer profile in the first direction of airflow through the outlet chamber 44. This improves the smoothness of airflow through the outlet chamber 44 towards the outlet opening 32 by reducing flow separation as the air flows around the inlet pipe 60. The streamlined shape helps recover some of the flow energy normally wasted in creation of separated flow, which has the effect of reducing the pressure drop of the separation system.

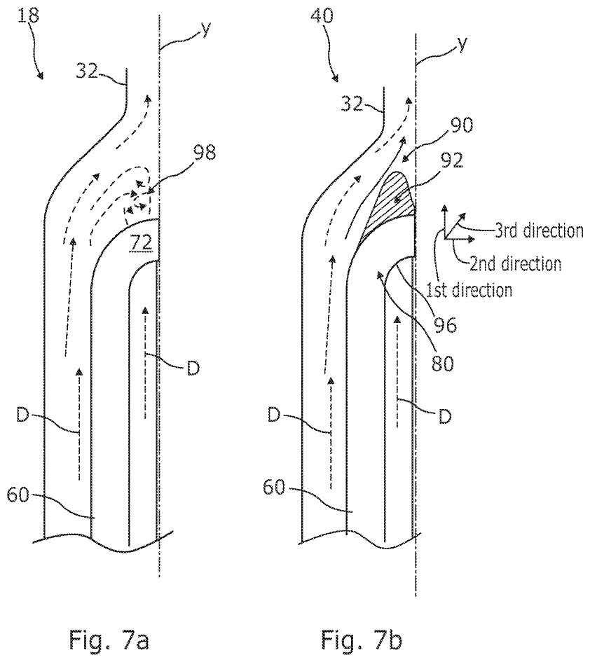

This can be appreciated more fully with reference also to FIG. 7b which shows a schematic representation of the dirt separator shown in FIGS. 6a and 6b. Note that the outer shape of the inlet pipe 60 shown in FIG. 7b has been exaggerated for clarity and illustration of principle. For comparison, FIG. 7a illustrates airflow through a dirt separator 18 which is comparable to the dirt separator 18 shown in FIGS. 3a and 3b.

Note that only approximately half of the dirt separator is shown in FIGS. 7a and 7b so the air flow through the outlet chamber 44 can be fully appreciated. The configuration of the dirt separator 18 in FIG. 7a does not form part of the invention.

Comparing FIG. 7b with FIG. 7a, it can be seen that the throat portion 80 of the inlet pipe 60 has a streamlining feature 90 that extends the outer profile of the inlet pipe 60 in the direction downstream of the airflow. The throat portion 72 of the inlet pipe 60 is therefore provided with a streamlined trailing section 92, in the direction of airflow through the outlet chamber 44. The streamlining feature 90 is in the form of a bulge, hump or projection that shapes the downstream part of the inlet pipe 60 to reduce flow separation behind the pipe. As a result of this streamlined trailing section 92 of the inlet pipe 60 the air flows upwards through the outlet chamber 44 and then around the throat portion 72 more smoothly than would be the case in the configuration shown in FIG. 7a.

In contrast to the streamlined trailing section 92, the other side 96 of the throat portion 72 of the inlet pipe 60, i.e. the leading section when considered in the direction of airflow, presents a bluff body to the airflow. When the bluff leading section 96 is considered with the streamlined trailing section 92, it will be appreciated that the combined effect is to define a teardrop like shape in the airflow which is a more efficient aerodynamic shape which presents less resistance to airflow. The teardrop-like shape can be appreciated from the inset detail in FIG. 6a.

The streamlined trailing section 92 may be a solid extension of the throat portion 80 of the inlet pipe 60, as shown in FIGS. 6a and 7b, although it may also be achieved by a hollow shell. Either approach would achieve the airflow benefits. Whilst a solid streamlined trailing section 92 may add mass to the overall mass of the vacuum cleaner, it is believed to be more straightforward to manufacture. In contrast, a hollow trailing section 92 may achieve some slight weight benefits but may be more complex to manufacture.

It should be noted that an oval or teardrop shape is not essential, albeit it is beneficial in terms of airflow. In principle, therefore, the outer profile of the throat portion 72 may have a configuration such that its dimension in the first direction, that is, in the direction of the airflow through the outlet chamber 44 is greater than the dimension of the throat portion 72 in a third direction, namely, the direction across the throat portion 72.

Expressed another way, the streamlined trailing section 92 of the inlet pipe 60 has an aspect ratio such that it is taller than it is wide, in the direction of airflow. Preferably the aspect ratio of the streamlined trailing section 72 should be greater than 1:1.2 but less than 1:2.

The first, second and third directions are indicated by the key in FIG. 7b. Note that the third direction is shown here on a Z-axis for clarity, but should be understood as directed into the page. It will be understood that the third direction is perpendicular to the second direction.

With reference to FIG. 7a, it can be appreciated that the flow of air through the outlet chamber 44, as indicated by the arrows D, passes along and around the inlet pipe 60 as the air progresses towards the outlet conduit 32. The throat portion 72 of the inlet pipe 60, being circular in outer profile, presents a bluff body to the air flow and therefore acts as an obstruction. The flow of air over the throat portion 72 therefore tends to separate on the trailing side of the throat portion 80 which causes a separation zone shown as 98 in FIG. 7a. This is a potentially significant source of pressure drop of the dirt separator 18.

By observing FIG. 7b, however, it can be appreciated that the streamlined trailing section 92 of the throat portion 72 means that the air flows much more smoothly over and around the inlet pipe 60 meaning that the airflow tends to remain attached to the bulbous streamlined trailing section 92 which reduces the pressure drop and improves the efficiency of the dirt separator 40.

It should be noted that features of the first example of the invention may be combined with features of the second example of the invention as appropriate, and unless explicated stated otherwise.

In an embodiment, a separation system for a vacuum cleaning appliance may be provided with the following clauses
1. A separation system for a vacuum cleaning appliance, comprising:
   a vacuum generator;
   an outlet chamber which extends in a first direction and which defines an air outlet, wherein air is drawn through the outlet chamber in the first direction by the vacuum generator, in use, towards the air outlet,
   an air permeable filter arrangement separating the outlet chamber from a dirt collection chamber;
   an air inlet pipe that extends through at least a portion of the outlet chamber and defines a discharge opening into the dirt collection chamber, wherein the inlet pipe has a flow area that increases along at least a portion of its length such that the air inlet pipe defines a first flow area at an upstream position relative to the discharge opening, wherein the discharge opening defines a second flow area, wherein the second flow area is larger than the first flow area.
2. The separation system of clause 1, wherein the flow area of the air inlet pipe increases continuously from the first flow area to the second flow area.
3. The separation system of clause 1 or 2, wherein the first flow area is defined by a first portion of the air inlet pipe which extends through the outlet chamber along the first direction.
4. The separation system of clause 3, wherein the first portion of the air inlet pipe extends for a length in the first direction and has a substantially constant flow area along its length.
5. The separation system of any one of the preceding clauses, wherein the discharge opening is defined by a second portion of the air inlet pipe which extends in a second direction which is generally traverse to the first direction.
6. The separation system of clause 5, when dependent on clause 4, wherein the air inlet pipe includes a transition portion extending between the first portion and the second portion.
7. The separation system of clause 6, wherein the transition portion defines a flow area that increases along its length.
8. The separation system of clause 7, wherein the flow area of the transition portion increases continuously along its length.
9. The separation system of any one of clauses 5 to 8, when dependent on clause 4, wherein the transition portion has at least a part which curves between the first portion and the second portion.
10. The separation system of any one the preceding clauses, wherein the second flow area is no more than 150% larger than the first flow area, and preferably no more than 120% larger than the first flow area.
11. The separation system of any one of the preceding clauses, wherein the dirt collection chamber extends along the first direction.
12. The separation system of clause 11, wherein the dirt collection chamber is parallel to the outlet chamber.
13. The separation system of any one of the preceding clauses, wherein the dirt collection chamber and the outlet chamber together define a cylindrical profile.
14. The separation system of clause 13, wherein the diameter of the cylindrical profile is less than 50% of the length of the output chamber along the first direction.

15. The separation system of clause 13, wherein the diameter of the cylindrical profile is less than 20% of the length of the output chamber along the first direction.
16. The separation system of clause 14 or 15, wherein the diameter of the cylindrical profile is greater than 10% of the length of the output chamber along the first direction.
17. The separation system of any one of the preceding clauses, wherein the filter arrangement comprises a filter sheet that extends along the first direction.
18. The separation system of clause 17, wherein the filter sheet has a first portion and a second portion, wherein the first portion is angled with respect to the second portion such that a vertex is defined between the first portion and second portion.
19. The separation system of clause 18, wherein the vertex is oriented to extend along the first direction.
20. The separation system of any one of the preceding clauses, wherein the air outlet is adjacent to the discharge opening.
21. The separation system of any preceding clauses, wherein the air outlet extends along the first direction.
22. A vacuum cleaning appliance comprising a handle, a user-operable interface, a power source, and a separation system as defined by clauses 1 to 21.
23. The vacuum cleaning appliance of clause 22, wherein the handle and the power source are contained within an elongate housing.
24. The vacuum cleaning appliance of clause 22 or 23, wherein the elongate housing is orientated to extend along the first direction of the separation system.

Some variants to the specific examples of the invention shown in the Figures and described above have already been described. However, the skilled person would understand that other variations and modifications may be made to those specific examples without departing from the scope of the invention as defined by the claims.

1. A separation system for a vacuum cleaning appliance, comprising:
a vacuum generator;
an outlet chamber which extends in a first direction and which defines an air outlet, wherein air is drawn through the outlet chamber in the first direction by the vacuum generator, in use, towards the air outlet,
an air permeable filter arrangement separating the outlet chamber from a dirt collection chamber; and
an air inlet pipe that extends through at least a portion of the outlet chamber, wherein the air inlet pipe includes a throat portion which defines a discharge opening into the dirt collection chamber, wherein the throat portion extends in a second direction that is transverse to the first direction, and
wherein the throat portion of the air inlet pipe is shaped to define a streamlined outer profile in respect of the first direction of air flow through the outlet chamber to the air outlet.

2. The separation system of claim 1, wherein the outer profile of the throat portion includes a bluff leading section and a streamlined trailing section with respect to the direction of air flow through the outlet chamber.

3. The separation system of claim 1, wherein the outer profile of the throat portion has a first dimension aligned with the first direction and a second dimension aligned with a third direction that is perpendicular to the second direction, wherein the first dimension is greater than the second dimension.

4. The separation system of claim 3, wherein the outer profile of the throat portion is generally oval.

5. The separation system of claim 1, wherein the throat portion defines an inner profile which is different to the outer profile.

6. The separation system of claim 5, wherein the inner profile of the throat portion is circular or generally oval.

7. (canceled)

8. The separation system of claim 5, wherein inner profile of the throat portion is generally oval, and wherein the generally oval inner profile is shaped so that the major axis thereof is transverse to the first direction.

9. The separation system of claim 1, wherein the dirt collection chamber extends along the first direction.

10. The separation system of claim 1, wherein the dirt collection chamber is parallel to the outlet chamber.

11. The separation system of claim 1, wherein the throat portion of the air inlet pipe is adjacent the air outlet opening.

12. The separation system of claim 1, wherein the dirt collection chamber and the outlet chamber together define a cylindrical profile.

13. The separation system of claim 12, wherein the diameter of the cylindrical profile is less than 50% of the length of the outlet chamber along the first direction.

14. The separation system of claim 12, wherein the diameter of the cylindrical profile less than 20% of the length of the outlet chamber along the first direction.

15. The separation system of claim 13, wherein the diameter of the cylindrical profile is greater than 10% of the length of the outlet chamber along the first direction.

16. The separation system of claim 1, wherein the air permeable filter arrangement comprises a filter sheet that extends along the first direction.

17. The separation system of claim 16, wherein the filter sheet has a first portion and a second portion, wherein the first portion is angled with respect to the second portion such that a spine is defined between the first portion and second portion.

18. The separation system of claim 17, wherein the spine is oriented to extend along the first direction.

19. A vacuum cleaning appliance comprising a handle, a user-operable interface, a power source, and the separation system as defined by Claim 1.

20. The vacuum cleaning appliance of claim 19, wherein the handle and the power source are contained within an elongate housing.

21. The vacuum cleaning appliance of claim 20, wherein the elongate housing is orientated to extend along the first direction of the separation system.
